(19) United States
(12) Patent Application Publication
(10) Pub. No.: US 2017/0320008 A1
(43) Pub. Date: Nov. 9, 2017

(54) Process For Selectively Removing Hydrogen Sulphide From Gaseous Mixtures And Use Of A Thioalkanol For Selectively Removing Hydrogen Sulphide

(71) Applicant: TOTAL S.A., Courbevoie (FR)

(72) Inventors: Claire WEISS, Vaucresson (FR); Renaud CADOURS, Francheville (FR); Jing ZHAO, Courbevoie (FR); Virenkumar SHAH, Cruden Bay (GB); Serge CAPDEVILLE, Poey De Lescar (FR)

(73) Assignee: TOTAL S.A., Courbevoie (FR)

(21) Appl. No.: 15/662,518

(22) Filed: Jul. 28, 2017

Related U.S. Application Data
(63) Continuation of application No. 14/402,515, filed on Nov. 20, 2014, now abandoned.

(30) Foreign Application Priority Data
May 25, 2012 (FR) 1254842

(51) Int. Cl. B01D 53/14; C10L 3/10; B01D 53/52

(52) U.S. Cl. CPC B01D 53/1468; B01D 53/1462; B01D 53/1493; B01D 53/52; B01D 53/1425; C10L 3/103; B01D 2252/602; B01D 2252/60; B01D 2252/504; B01D 2252/2056; B01D 2252/20489; B01D 2252/20484; B01D 2252/20431; B01D 2252/20405; B01D 2257/304; B01D 2257/306; B01D 2257/308; C10L 2290/12; Y02C 10/06; C10L 2290/541

(57) ABSTRACT

A process for selectively removing hydrogen sulphide relative to carbon dioxide from a gaseous mixture containing at least hydrogen sulphide H₂S and carbon dioxide CO₂, includes a step of contacting the gaseous mixture with an absorbent solution including at least one amine, water, and at least one C₂ to C₄ thioalkanol. A use of the absorbent solution for selectively removing hydrogen sulphide relative to carbon dioxide from a gaseous mixture containing at least hydrogen sulphide and carbon dioxide, is disclosed. Disclosed is a use of at least one C₂ to C₄ thioalkanol as an additive in an absorbent solution including at least one amine, and water, for increasing the selectivity of the absorbent solution for the removal of hydrogen sulphide relative to carbon dioxide from a gaseous mixture containing at least hydrogen sulphide and carbon dioxide.

### CROSS-REFERENCE TO RELATED APPLICATIONS

This application is continuation of U.S. patent application Ser. No. 14/402,515, filed on Nov. 20, 2014, which is a National Phase Entry of International Application No. PCT/EP2013/060578, filed on May 23, 2013, which claims priority to French Patent Application Serial No. 1254842, filed on May 25, 2012, all of which are incorporated by reference herein.

### BACKGROUND AND SUMMARY

The present invention relates to a process for selectively removing hydrogen sulphide from gaseous mixtures. More precisely, the present invention relates to a process for selectively removing hydrogen sulphide in the presence of carbon dioxide from a gaseous mixture containing hydrogen sulphide and carbon dioxide.

The present invention further relates to the use of a thioalkanol for selectively removing hydrogen sulphide. More precisely, the present invention further relates to the use of an absorbent solution comprising a thioalkanol for selectively removing hydrogen sulphide in the presence of carbon dioxide from a gaseous mixture containing hydrogen sulphide and carbon dioxide, as well as the use of a thioalkanol as additive in an absorbent solution for increasing the selectivity of said absorbent solution vis-ä-vis the removal of hydrogen sulphide in the presence of carbon dioxide from a gaseous mixture containing hydrogen sulphide and carbon dioxide. The invention applies in particular to the selective removal of H₂S from natural gases, to supply on the one hand a gaseous stream free from H₂S or having a content of H₂S below a specified threshold, intended for example for supplying a distribution system for natural gas for domestic use, and on the other hand an acidic gaseous stream rich in H₂S intended for example for supplying a plant for the production of sulphur, for example by the CLAUS process, or for the synthesis of thio-organic compounds.

The purification of gaseous mixtures and in particular of hydrocarbon gaseous mixtures such as natural gas, or others such as synthesis gases, in order to remove contaminants and impurities from them, is a common operation in industry. These impurities and contaminants are in particular “acidic gases”, for example carbon dioxide (CO₂) and hydrogen sulphide (H₂S); other sulphur-containing compounds different from hydrogen sulphide (H₂S), such as for example carbonyl sulphide (COS) and the mercaptans (R—SH, where R is an alkyl group); water; and certain hydrocarbons. Carbon dioxide and hydrogen sulphide can represent a large proportion of the gaseous mixture originating from a natural-gas deposit, typically from 3% to 70% by volume, whereas COS is present in much smaller quantities, typically ranging from 1 to 100 ppm by volume, and the mercaptans are present at a content generally below 1000 ppm by volume, for example comprised between 5 ppm by volume and 500 ppm by volume.

The natural gas originating from a deposit thus undergoes several treatments in order to comply with specifications that are in particular dictated by commercial constraints, transport constraints or constraints connected with safety. These treatments are in particular deacidizing, dehydrating, and stripping treatments. This last-mentioned treatment consists of separating ethane, propane, butane and gasolines, forming liquefied petroleum gas (“LPG”), from the methane gas that is sent to the distribution system.

It is possible to try to remove all the acidic gases contained in a gaseous mixture such as natural gas simultaneously. However, it may also be desired to extract the H₂S selectively relative to the CO₂ contained in a gaseous mixture such as natural gas. In fact, the specifications for the content of acidic gas in the gas being treated are specific to each product under consideration. Contents of a few ppm are imposed for H₂S, whereas some specifications for CO₂ are up to a few percent, generally 2%. Under these conditions, an optimum process will allow selective removal of H₂S relative to CO₂, with minimal or controlled co-absorption of the CO₂.

The first challenge in the selective removal of H₂S relates firstly to energy. Minimizing the quantity of CO₂ absorbed leads directly to minimization of the size and the operating costs of the plant. Moreover, minimizing the co-absorption of CO₂ is important because the H₂S recovered is then sent to units using the Claus reaction for converting H₂S to sulphur.

The performance of these “Claus” units is closely linked to the concentration of H₂S in the acidic gas recovered at the outlet of the natural gas deacidizing units: the higher the H₂S concentration, the higher the performance of these processes and the less their exposure to the other impurities contained in their feedstock. The H₂S-rich gas sent to the CLAUS unit should generally comprise at least 30% by volume of H₂S.

The known processes for selectively removing H₂S can be classified in three main categories. The first category includes processes that use physical solvents and are based on the physical absorption of the acidic gases in this solvent. Typical physical solvents are methanol, N-methylpyrrolidone, and the dialkyl (dimethyl) ethers of polyethylene glycol. These physical solvents have the drawback that they also absorb large quantities of hydrocarbons and in particular hydrocarbons having a number of carbon atoms greater than that of propane, which can in particular be present in natural gas. These hydrocarbons will end up in the gas stream sent to the “Claus” unit, which is extremely troublesome.

The second category includes the oxidation processes based on the oxidation of H₂S to give sulphur such as the Giammarco process or the Stretford process, but these processes pose significant environmental problems. The third category includes the processes using chemical absorption by aqueous solutions of amines, preferably of tertiary amines. In contact with the acidic gases, these amines form salts, which can be decomposed by heating and/or removed by steam stripping.

These processes owe their selectivity to the fact that the chemical reaction of H₂S with the tertiary amine is very fast, and much faster than the reaction with carbon dioxide, which remains kinetically limited. This difference between the respective reaction rates of CO₂ and of H₂S with these tertiary amines, optionally combined with optimization of gas-liquid contact, thus allows selective removal of H₂S.

These processes are well known to a person skilled in the art in this area of technology, and include for example the AdvAmines MDEAmax process offered by the company Prosernat. Other processes are offered by the companies BASF and EXXON-MOBIL and use special formulations for optimizing the selective removal of H₂S. These processes are based on optimization of the tertiary amines used.

Thus, document FR-A1-2 328 657 relates to a process for H₂S enrichment of acidic gases containing H₂S, CO₂ and a hydrocarbon proportion below 5%, in which the gases are scrubbed in countercurrent with an aqueous solution of methyldiethanolamine (MDEA).

Document WO-A1-87/01961 describes a process and a device for selectively removing H₂S from a gas containing it, in which the gas to be treated is contacted, in an absorption zone, with an absorbent liquid that is selective for H₂S and can be regenerated by heating. The absorbent liquid can be based on one or more solvents with physical action or can consist of a solvent with chemical action formed for example by an aqueous solution of an alkanolamine such as methyldiethanolamine (MDEA) or triethanolamine (TEA). The absorbent liquid can also be selected from mixtures of the aforementioned two types of solvent with chemical action and with physical action. It is stated that an aqueous solution of an alkanolamine such as methyldiethanolamine or triethanolamine is quite particularly suitable as absorbent liquid selective for H₂S.

U.S. Pat. No. 4,519,991 relates to H₂S enrichment of a gas by selective absorption with an aqueous solution of methyldiethanolamine. U.S. Pat. No. 4,545,965 relates to the selective separation of H₂S from gaseous mixtures that also contain CO₂ by chemical absorption with an anhydrous solution of a tertiary amine such as methyldiethanolamine, and an auxiliary organic solvent such as sulpholane. However, in all these processes that use an alkanolamine and in particular a tertiary alkanolamine, some of the CO₂ present in the gas is inevitably co-absorbed.

In view of the foregoing, it therefore appears that the problem of truly selective removal of the H₂S contained in a gaseous mixture, and in particular in natural gas, in the presence of CO₂ has not yet been solved satisfactorily. It should also be noted that the technologies used for selectively removing H₂S, and in particular those using absorbent aqueous amine solutions, generally have very limited performance for the removal of the other sulphur-containing compounds, such as the mercaptans. In fact, optimization of the removal process to promote only the absorption of H₂S leads to dimensioning of the apparatus and to operating conditions that are very unfavourable for the removal of the other sulphur-containing compounds such as the mercaptans.

The rates of removal of the mercaptans are often below 20% with these technologies. Now, the sulphur-containing compounds such as the mercaptans that are not removed during the deacidizing step may end up in the gas distribution system, and necessitate additional steps for their removal in units for dehydration, or stripping and separation. It would therefore possibly be of interest, while improving the selectivity of the removal of hydrogen sulphide relative to CO₂, also to improve the removal of the other sulphur-containing compounds such as the mercaptans.

### BRIEF DESCRIPTION OF THE DRAWINGS

FIG. 1 is a graph showing the results of comparative absorption tests of CO₂ contained in a gaseous mixture, by two absorbent solutions, carried out in a pilot plant comprising an absorption column that has 11 plates. The absorption tests were carried out at a pressure of 18 bar with a so-called reference absorbent solution comprising 55% by weight of water and 45% by weight of MDEA (curve connecting measurement points represented by “▴”) or an absorbent solution that is an absorbent solution used according to the invention comprising 38% by weight of water, 45% by weight of MDEA and 17% by weight of TDG (curve connecting measurement points represented by “”). The number of the plate of the absorption column is plotted on the abscissa, and the rate of removal of CO₂ is plotted on the ordinate (as a percentage relative to the initial CO₂ content in the gaseous mixture).

FIG. 2 is a graph showing the results of comparative absorption tests of H₂S contained in a gaseous mixture, by two absorbent solutions, carried out in a pilot plant comprising an absorption column that has 11 plates. The absorption tests were carried out at a pressure of 18 bar with a so-called reference absorbent solution comprising 55% by weight of water and 45% by weight of MDEA (curve connecting measurement points represented by “▴”) or an absorbent solution that is an absorbent solution used according to the invention comprising 38% by weight of water, 45% by weight of MDEA and 17% by weight of TDG (curve connecting measurement points represented by “”).

FIG. 3 is a graph showing the results of comparative absorption tests of CO₂ contained in a gaseous mixture, by two absorbent solutions, carried out in a pilot plant comprising an absorption column that has 11 plates. The absorption tests were carried out at a pressure of 40 bar with a so-called reference absorbent solution comprising 55% by weight of water and 45% by weight of MDEA (curve connecting measurement points represented by “▴”) or an absorbent solution that is an absorbent solution used according to the invention comprising 38% by weight of water, 45% by weight of MDEA and 17% by weight of TDG (curve connecting measurement points represented by “”). The number of the plate of the absorption column is plotted on the abscissa, and the rate of removal of CO₂ is plotted on the ordinate (as a percentage relative to the initial CO₂ content in the gaseous mixture).

FIG. 4 is a graph showing the results of comparative absorption tests of H₂S contained in a gaseous mixture, by two absorbent solutions, carried out in a pilot plant comprising an absorption column that has 11 plates. The absorption tests were carried out at a pressure of 40 bar with a so-called reference absorbent solution comprising 55% by weight of water and 45% by weight of MDEA (curve connecting measurement points represented by “▴”) or an absorbent solution that is an absorbent solution used according to the invention comprising 38% by weight of water, 45% by weight of MDEA and 17% by weight of TDG (curve connecting measurement points represented by “”). The number of the plate of the absorption column is plotted on the abscissa, and the rate of removal of CO₂ is plotted on the ordinate (as a percentage relative to the initial CO₂ content in the gaseous mixture).

FIG. 5 is a graph showing the results of absorption tests of gaseous CO₂, by absorbent solutions including three absorbent solutions used according to the invention, carried out in the laboratory, in a reactor permitting control of the contact area between gas and absorbent solution. The absorption tests were carried out at a temperature of 60° C. with solutions comprising water, DEA in equal quantities by weight and TDG in respective quantities of 0% by weight, 10% by weight, 20% by weight and 30% by weight. The percentage by weight of thiodiglycol TDG in the absorbent solution is plotted on the abscissa and the flow standardized by the carbon dioxide pressure in the reactor at the moment of measurement is plotted on the ordinate.

FIG. 6 is a graph showing the results of absorption tests of gaseous CO₂, by absorbent solutions including three absorbent solutions used according to the invention, carried out in the laboratory, in a reactor permitting control of the contact area between gas and absorbent solution. The absorption tests were carried out at a temperature of 60° C. with solutions comprising water, MDEA in equal quantities by weight, and TDG in respective quantities of 0% by weight, 10% by weight, 20% by weight and 30% by weight. The percentage by weight of thiodiglycol TDG in the absorbent solution is plotted on the abscissa and the flow standardized by the carbon dioxide pressure in the reactor at the moment of measurement is plotted on the ordinate.

### DETAILED DESCRIPTION

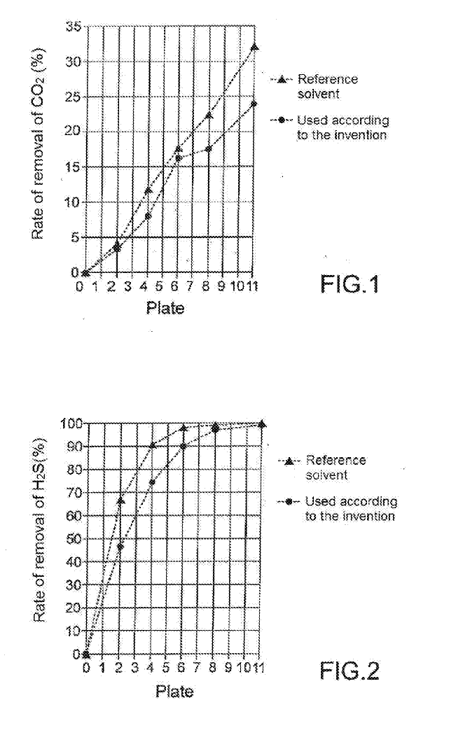

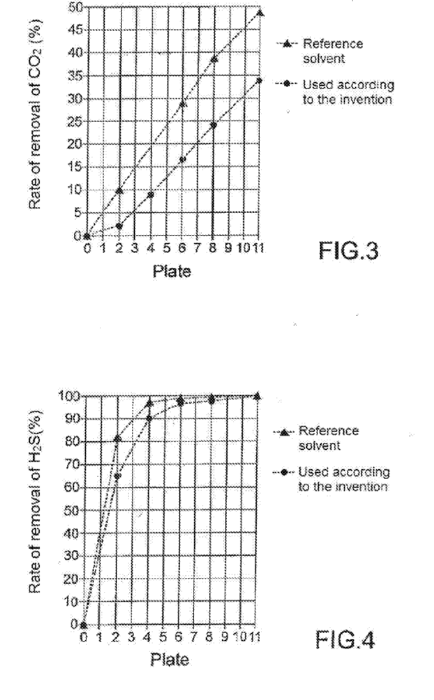

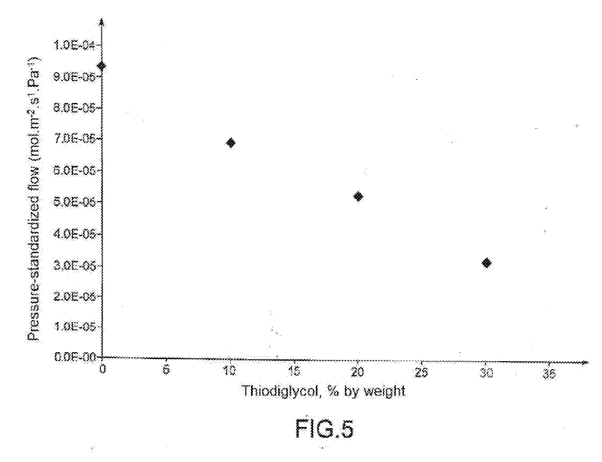

The inventors demonstrated that, surprisingly, the addition of a C₂ to C₄ thioalkanol such as ThioDiGlycol (TDG) to an absorbent solution, an absorption mixture comprising an amine and water, allowed a considerable improvement in the selectivity of said absorbent solution for the removal of hydrogen sulphide relative to carbon dioxide in a gaseous mixture containing hydrogen sulphide and carbon dioxide. This improvement in selectivity was in particular demonstrated for secondary amines and tertiary amines (see Example 1, FIGS. 1 to 4). Thus, the absorbent solution water-MDEA (MethylDiEthanolAmine)-TDG has, owing to the presence of TDG, a selectivity for H₂S that is far higher than that of a water-MDEA absorbent solution without TDG. Similarly, the absorbent solution water-DEA (DiEthanolAmine)-TDG has, owing to the presence of TDG, a selectivity for H₂S that is far higher than that of a water-DEA absorbent solution without TDG.

A person skilled in the art will understand that these results, demonstrating that the addition of a thioalkanol, such as TDG, to absorbent solutions of water and a secondary or tertiary amine improves the selectivity of the latter for the removal of hydrogen sulphide from a gaseous mixture, can easily be generalized to any absorbent solution comprising any amine whatever, and water, and in particular to all the absorbent solutions that are selective for H₂S that are already known and marketed. Without wishing to be bound by any theory, it appears that the thioalkanol, which can be described as a cosolvent, affects the interactions between CO₂ and the absorbent solution.

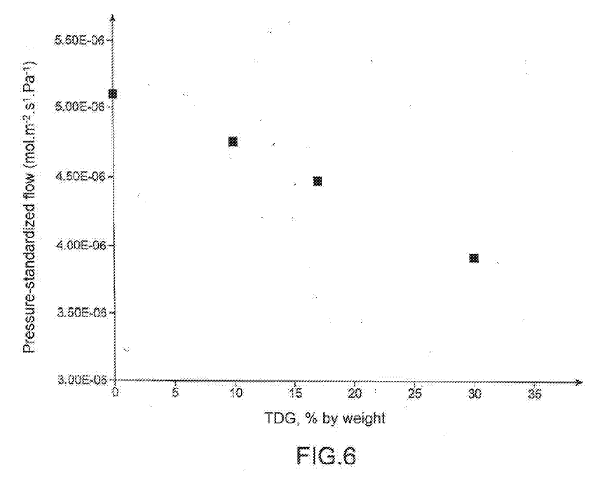

Kinetic tests were carried out for the systems CO₂/water-DEA-TDG and CO₂/water-MDEA-TDG (see Example 2 and FIGS. 5 and 6). These laboratory tests detected an unexpected effect of TDG on the interactions between acidic gases and the amine. In fact, in the presence of TDG, the chemical reactions between amine and acidic gases are slowed down.

Surprisingly, the effect is particularly marked on CO₂. H₂S, which reacts instantaneously with the amines relative to the transfer phenomena, is ultimately not significantly affected by the presence of TDG. A person skilled in the art will understand that this phenomenon, detected and proven for secondary amines and tertiary amines, can easily be generalized to all the amines.

The thioalkanol, such as TDG, proves be a decisive element of the formulation of the absorbent solution, which makes it possible to optimize the selective removal of H₂S relative to CO₂. Moreover, the absorbent solution comprising an amine, water and a thioalkanol, such as the water-MDEA-TDG absorbent solution, also displays, surprisingly, owing to the presence of the thioalkanol, such as TDG, relative to a similar absorbent solution not comprising thioalkanol, such as the water-MDEA absorbent solution, the advantageous property of improving the removal of other sulphur-containing compounds such as the mercaptans that may be contained in the gaseous mixture. The size of the units provided downstream for removing other sulphur-containing compounds such as the mercaptans can thus be reduced.

It is quite astonishing that, owing to the addition of a thioalkanol to the absorbent solution, it is possible to obtain both excellent selectivity, comparatively improved for H₂S, and improved removal of the mercaptans. These results were all demonstrated in studies conducted on a pilot unit comparing the solvents water-MDEA and water-MDEA-TDG, namely:
better selective removal of H₂S vis-à-vis CO₂ (see Example 1);
better removal of the mercaptans;
energy savings.

The invention makes it possible to reduce the capital costs (“CAPEX”) and operating costs (“OPEX”) of the installations for treating gases and in particular natural gas through reduction of the quantities of CO₂ absorbed, through energy savings, and through reduction of the size of the units provided downstream. The invention thus relates to a process for selectively removing hydrogen sulphide H₂S relative to carbon dioxide CO₂ in a gaseous mixture containing at least hydrogen sulphide H₂S and carbon dioxide CO₂, comprising a step of contacting said gaseous mixture with an absorbent solution comprising, preferably constituted by, at least one amine, water, and at least one C₂ to C₄ thioalkanol. The gaseous mixture to be treated can be any gaseous mixture containing H₂S and carbon dioxide CO₂. Generally, besides H₂S and CO₂, this gaseous mixture can contain at least one other sulphur-containing compound (different from H₂S) preferably selected from the mercaptans and carbonyl sulphide COS.

Preferably, the mercaptans having the formula R—SH (where R is an alkyl radical comprising for example from 1 to 10 carbon atoms, in particular from 1 to 6 carbon atoms) comprise methyl mercaptan and ethyl mercaptan, but other mercaptans, and in particular molecules of the type C₃SH to C₆SH, can be present, generally at lower concentrations than the methyl mercaptan and ethyl mercaptan. The content of hydrogen sulphide H₂S in the gaseous mixture to be treated is generally comprised between 30 ppm by volume and 40% by volume, and after the contacting step this content can be lowered to 1 ppm by volume. The CO₂ content of the gaseous mixture to be treated is generally comprised between 0.5% by volume and 80% by volume, preferably between 1% by volume and 50% by volume, and even more preferably between 1% by volume and 15% by volume.

The gaseous mixture to be treated can contain at least one mercaptan at a content generally below 1000 ppm by volume, preferably between 5 ppm by volume and 500 ppm by volume, and the process according to the invention makes it possible to remove a proportion of mercaptans 2 to 3 times greater than is observed with the processes using a solution without thioalkanol. The gaseous mixture to be treated can contain COS at a content generally below 200 ppm by volume, preferably comprised between 1 ppm and 100 ppm by volume.

Gaseous mixtures that contain hydrogen sulphide, carbon dioxide, and optionally at least one other sulphur-containing compound, are for example natural gas, synthesis gas, cracked gas, coke-oven gas, gas from coal gasification, landfill gas, biogas, and flue gases. The gaseous mixture can be a hydrogenated gaseous mixture, i.e. containing as principal component hydrogen, or hydrogen and carbon dioxide or hydrogen and carbon monoxide. Preferably, the gaseous mixture is a hydrocarbon gaseous mixture, i.e. it contains one or more hydrocarbons as principal component. These hydrocarbons are for example saturated hydrocarbons such as C1 to C4 alkanes such as methane, ethane, propane and butane, unsaturated hydrocarbons such as ethylene or propylene, or aromatic hydrocarbons such as benzene, toluene or xylene.

Said hydrocarbon gaseous mixture can be selected from natural gases, tail gases obtained at the outlet of the sulphur chains (CLAUS unit), and the gases obtained in the units for treating gases (“gas plant”) of a refinery. Natural gases have very variable pressures, which can range for example from 10 to 100 bar, and temperatures that can range from 20° C. to 60° C. The CO₂ and H₂S contents of natural gases are also very variable. They can be up to 15% by volume for each of these two compounds and can even be up to 40% for H₂S.

The tail gases obtained at the outlet of the sulphur chains, or the feed gases of the H₂S enrichment units located upstream of the CLAUS processes, generally have a very low pressure, for example below 3 bar, most often below 2 bar, and the temperatures of these gases are generally comprised between 40° C. and 70° C. The H₂S contents of these tail gases are generally below 5% by volume, and often below 2% by volume. In contrast, the CO₂ contents of these tail gases are variable and can reach 80% by volume.

By selective removal of hydrogen sulphide in the presence of carbon dioxide, or relative to carbon dioxide, is generally meant that the selectivity S of the absorbent solution for H₂S, relative to CO₂ given by the following formula is above 1:

$$\frac{\frac{{c ( {H}_{2} S )}_{mixture} - {c ( {H}_{2} S )}_{mixture after treatment}}{{c ( {H}_{2} S )}_{mixture}}}{\frac{{c ( {CO}_{2} )}_{mixture} - {c ( {CO}_{2} )}_{mixture after treatment}}{{c ( {CO}_{2} )}_{mixture}}}$$

where
c(H₂S)ₘᵢₓₜᵤᵣₑ is the H₂S concentration by volume in the gaseous mixture before treatment with the absorbent solution;
c(H₂S)_{mixture after treatment} is the H₂S concentration by volume in the gaseous mixture after treatment with the absorbent solution;
c(CO₂)ₘᵢₓₜᵤᵣₑ is the CO₂ concentration by volume in the gaseous mixture before treatment with the absorbent solution;
c(CO₂)_{mixture after treatment} is the CO₂ concentration in the gaseous mixture after treatment with the absorbent solution.

According to the invention, the selectivity S of the absorbent solution containing a thioalkanol is 5% to 50% higher, for example 8% to 15% higher, than the selectivity S of the same solution without thioalkanol. Generally, the C₂ to C₄ thioalkanol has the formula: R—S—(C₂-C₄ alkylene)-OH, where R is any group, for example an alkyl group (generally C₁ to C₆) or an alkanol group (generally C₁ to C₆), or a thiol group, or an alkylthioalkanol group (generally C₁ to C₆). According to a preferred embodiment, the C₂ to C₄ thioalkanol is a dimeric molecule.

An example of C₂ to C₄ thioalkanol that can be used according to the invention is ethylene dithioethanol of formula (HO—CH₂—CH₂)—S—(CH₂—CH₂)—S—(CH₂—CH₂—OH). The preferred thioalkanol is thiodiethylene glycol or thiodiglycol (TDG), which is the compound of formula S(CH₂—CH₂—OH)₂. Besides TDG, other C₂-C₄ thioalkanols can also be used according to the invention, in particular methylthioethanol. A mixture of several thioalkanols can also be used.

Any amine can be used in the absorbent solution, in particular the amines used in the known processes for selective removal of H₂S. The amine can be for example a primary, secondary or tertiary, aliphatic, cyclic, or aromatic amine. However, the amine used must generally be water-soluble at the concentrations used in the absorbent solution.

By “primary amine” within the meaning of the invention is generally meant a compound comprising at least one primary amine function. By “secondary amine” within the meaning of the invention is generally meant a compound comprising at least one secondary amine function. By “tertiary amine” within the meaning of the invention is generally meant a compound comprising at least one tertiary amine function and preferably comprising only tertiary amine functions. These primary, secondary or tertiary amines can be selected from aliphatic amines, cyclic amines, or others.

Examples of amines that can be used according to the invention are in particular given in U.S. Patent Publication No. 2010/0288125, the description of which can be referred to. Advantageously, the amine is selected from the alkanolamines (amino alcohols). These alkanolamines can be primary, secondary or tertiary.

It may be recalled that the alkanolamines or amino alcohols are amines comprising at least one hydroxyalkyl group (comprising for example from 1 to 10 carbon atoms) bound to the nitrogen atom. The tertiary alkanolamines can be trialkanolamines, alkyldialkanolamines or dialkylalkanolamines. The secondary alkanolamines can be dialkanolamines, or alkylalkanolamines, and the primary alkanolamines are monoalkanolamines.

The alkyl groups and the hydroxyalkyl groups of the alkanolamines can be linear or branched and generally comprise from 1 to 10 carbon atoms, preferably the alkyl groups comprise from 1 to 4 carbon atoms, and the hydroxyalkyl groups comprise from 2 to 4 carbon atoms. Examples of these alkanolamines are 2-aminoethanol (monoethanolamine, MEA), N,N-bis(2-hydroxethyl)amine (diethanolamine, DEA), N,N,-bis(2-hydroxypropyl)amine (diisopropanolamine, DIPA), tris(2-hydroxyethyl)amine (triethanolamine, TEA), tributanolamine, bis(2-hydroxyethyl)-methylamine (methyldiethanolamine, MDEA), 2-diethylaminoethanol (diethylethanolamine, DEEA), 2-dimethylaminoethanol (dimethylethanolamine, DMEA), 3-dimethylamino-1-propanol (N,N-dimethylpropanolamine), 3-diethylamino-1-propanol, 2-diisopropylaminoethanol (DIEA), N,N-bis(2-hydroxypropyl)methylamine (methyldiisopropanolamine, MDIPA), 2-amino-2-methyl-1-propanol (AMP), 1-amino-2-methyl-propan-2-ol, 2-amino-1-butanol (2-AB).

Examples of tertiary amines and in particular of tertiary alkanolamines are given in U.S. Patent Publication No. 2008/0025893, the description of which can be referred to. It is in particular N-methyldiethanolamine (MDEA), N,N-diethylethanolamine (DEEA), N,N-dimethylethanolamine (DMEA), 2-diisopropylaminoethanol (DIEA), N,N,N′,N′-tetramethylpropanediamine (TMPDA), N,N,N′,N′-tetraethylpropanediamine (TEPDA), dimethylamino-2-dimethylamino-ethoxyethane (Niax), and N,N-dimethyl-N′,N′-diethylethylenediamine (DMDEEDA).

Examples of tertiary alkanolamines that can be used in the process according to the invention are also given in U.S. Patent Publication No. 2010/0288125, the description of which can be referred to. It is in particular tris(2-hydroxyethyl)amine (triethanolamine, TEA), tris(2-hydroxypropyl)amine (triisopropanol), tributylethanolamine (TEA), bis(2-hydroxyethyl)methylamine (methyldiethanolamine, MDEA), 2-diethylaminoethanol (diethylethanolamine, DEEA), 2-dimethylaminoethanol (dimethylethanolamine DMEA), 3-dimethylamino-1-propanol, 3-diethylamino-1-propanol, 2-diisopropylaminoethanol (DIEA), N,N-bis(2-hydroxypropyl)methylamine (methyldiisopropanolamine, MDIPA).

Other examples of tertiary alkanolamines that can be used in the process according to the invention are given in U.S. Pat. No. 5,209,914, the description of which can be referred to, these are in particular N-methyldiethanolamine, triethanolamine, N-ethyldiethanolamine, 2-dimethylaminoethanol, 2-dimethylamino-1-propanol, 3-dimethylamino-1-propanol, 1-dimethylamino-2-propanol, N-methyl-N-ethylethanolamine, 2-diethylaminoethanol, 3-dimethylamino-1-butanol, 3-dimethylamino-2-butanol, N-methyl-N-isopropylethanolamine, N-methyl-N-ethyl-3-amino-1-propanol, 4-dimethylamino-1-butanol, 4-dimethylamino-2-butanol, 3-dimethylamino-2-methyl-1-propanol, 1-dimethylamino-2-methyl-2-propanol, 2-dimethylamino-1-butanol and 2-dimethylamino-2-methyl-1-propanol.

The amine can also be selected from the amino ethers. Examples of said amino ethers are 2-2-(aminoethoxy)ethanol (AEE), 2-(2-t-butylaminoethoxy)ethanol (EETB), and 3-methoxypropyldimethylamine. The amine can also be selected from saturated heterocycles with 3, 5, 6, or 7 members comprising at least one NH group contained in the ring. The ring can optionally further comprise one or two other heteroatoms in the ring selected from nitrogen and oxygen, and can optionally be substituted with one or more substituents selected from the alkyl radicals comprising 1 to 6 carbon atoms such as the ethyl or methyl radicals, the aminoalkyl radicals comprising 1 to 6 carbon atoms, and the hydroxyalkyl radicals comprising 1 to 6 carbon atoms.

Examples of said heterocycles are piperazine, 2-methylpiperazine, N-methylpiperazine, N-ethylpiperazine, N-aminoethylpiperazine (AEPZ), aminopropylpiperazine, N-hydroxyethylpiperazine (HEP), homopiperazine, bis(hydroxyethyl)piperazine, piperidine, aminoethylpiperidine (AEPD), aminopropylpiperidine, furfurylamine (FA) and morpholine (MO).

The amine used according to the invention can finally be selected from the polyamines such as the alkylenepolyamines, the bis(tertiary diamines) and the polyalkylenepolyamines. Among the alkylene diamines, there may be mentioned hexamethylenediamine, 1,4-diaminobutane, 1,3-diaminopropane, 2,2-dimethyl-1,3-diaminopropane, 3-methylaminopropylamine, N(2-hydroxyethyl)ethylenediamine, 3(dimethylaminopropylamine) (DMAPA), 3(diethylamino)propylamine, and N,N′-bis(2-hydroxyethyl)ethylenediamine.

Among the bis(tertiary diamines), there may be mentioned N,N,N′,N′-tetramethylethylenediamine, N,N-diethyl-N′,N′-dimethylethylenediamine, N,N,N′,N′,-tetraethylethylenediamine, N,N,N′,N′-tetramethyl-1,3-propanediamine (TMPDA), N,N,N′,N′-tetraethyl-1,3-propanediamine (TEPDA), N,N-dimethyl-N′,N′-diethylethylenediamine (DMDEEDA), 1-dimethylamino-2-dimethylaminoethoxy-ethane (bis[2-(dimethylamino)ethyl]ether) mentioned in U.S. Patent Publication No. 010/0288125, the description of which can be referred to. Among the polyalkylenepolyamines, there may be mentioned dipropylenetriamine (DTPA), diethylenetriamine (DETA), triethylenetetramine (TETA), tetraethylenepentamine (TEPA), hexamethylenediamine (HMDA), tris(3-aminopropyl)amine, and tris(2-aminoethyl)amine.

In an embodiment, the absorbent solution comprises only amines comprising only tertiary amine groups and/or sterically hindered amine groups. Preferred amines comprising only tertiary amine groups are tris(2-hydroxyethyl)amine (triethanolamine, TEA), tris(2-hydroxypropyl)amine (triisopropanol), tributanolamine, bis(2-hydroxyethyl)methylamine (methyldiethanolamine, MDEA), 2-diethylaminoethanol (diethylethanolamine, DEEA), 2-dimethylaminoethanol (dimethylethanolamine DMEA), 3-dimethylamino-1-propanol, 3-diethylamino-1-propanol, 2-diisopropylaminoethanol (DIEA), N,N-bis(2-hydroxypropyl)methylamine (methyldiisopropanolamine, MDIPA). Preferred amines comprising only sterically hindered amine groups are 2-amino-2-methyl-1-propanol (AMP) and 1-amino-2-methylpropan-2-ol. The preferred amine is MDEA.

Generally, the absorbent solution comprises, preferably is constituted by:
from 20% to 60%, preferably from 30% to 50%, more preferably from 40% to 45% by weight of at least one amine;
from 20% to 60%, preferably from 30% to 50%, more preferably from 35% to 45% by weight of water;
from 10% to 40%, preferably from 15% to 30%, more preferably from 17% to 25% by weight of at least one thioalkanol.

Among these absorbent solutions, the absorbent solutions that comprise MDEA as amine, TDG as thioalkanol, and water in the aforementioned proportions are preferred. An absorbent solution that is particularly preferred is the absorbent solution constituted by water, MDEA, and TDG in the respective proportions of 38% by weight, 45% by weight, and 17% by weight.

Advantageously, the contacting step is carried out at a temperature generally from 40° C. to 100° C., preferably from 50° C. to 90° C., and at a pressure from 1 to 150 bar, preferably from 10 to 70 bar. Advantageously, the process for selective removal as described above further comprises, after the contacting step, a step of regenerating the absorbent solution. Advantageously, said step of regenerating the absorbent solution is carried out at a pressure from 0 to 20 bar, preferably from 1 to 3.5 bar, more preferably from 1 to 2 bar, and at a temperature from 100° C. to 140° C.

The invention can be applied in any conventional installation for absorption and regeneration using chemical absorbent solutions. Such an installation is in particular described in document WO-A1-2007/083012, the description of which can be referred to. Any apparatus for liquid-liquid contact can be used for carrying out the contacting (absorption) step.

In particular, any type of column can be used as the absorption column. It can in particular be a perforated-plate column, a valve column or a bulb-fractionating column. Columns with bulk or structured packing can also be used. Static in-line solvent mixers can also be used.

For the sake of simplicity, the terms “absorption column” or “column” are used hereinafter to denote the liquid-liquid contact apparatus, but of course any apparatus for liquid-liquid contact can be used for carrying out the absorption step. Thus, the contacting (absorption) step can be carried out for example in an absorption column, at a temperature generally from 40° C. to 100° C., preferably from 50° C. to 90° C. and at a pressure from 1 to 150 bar, preferably from 10 to 70 bar.

Absorption is carried out by contacting the gaseous mixture with the absorbent solution at a gaseous mixture flow rate generally from 0.23×10⁶ Nm³/day to 56×10⁶ Nm³/day and at a flow rate of absorbent solution generally from 800 to 50000 m³/day. The step of regenerating the absorbent solution is applied conventionally by heating and separation of the mercaptans RSH and acidic gases, including H₂S, in a regenerating column. This step of regenerating the absorbent solution is generally carried out under the conditions of temperature and pressure already stated above.

In fact, the amine solution laden with acidic gases such as H₂S, CO₂ and with mercaptans RSH—called amine-rich—from the bottom of the absorption column is sent to an intermediate-pressure flash drum. The gases resulting from expansion of the amine-rich can be used as fuel gases, however, according to the invention, these gases heavily laden with H₂S are preferably treated, or optionally sent directly to a unit for the production of sulphur using the Claus reaction of controlled oxidation of H₂S or to a plant for the synthesis of thio-organic compounds. According to the invention, the gas sent to the Claus unit is very rich in H₂S and the size of this unit and the associated costs can thus be reduced considerably.

The amine-rich is then heated in an amine/amine exchanger by the hot amine from the bottom of the regenerator, and optionally is partially vaporized and then recycled to feed the regenerating column. A reboiler generates steam, which ascends in counter-current in the column, entraining the acidic constituents such as H₂S and CO₂ and the mercaptans RSH. This desorption is promoted by the low pressure and high temperature prevailing in the regenerator.

At the top of the column, the acidic gases are cooled in a condenser. The condensed water is separated from the acidic gas in a reflux drum and returned either to the top of the regenerating column, or directly to the tank of amine-poor solution. The regenerated amine, which is therefore also called amine-poor, is then recycled to the absorption step. A semi-regenerated operating mode can also be envisaged.

Thus, a fraction of the partially regenerated solvent taken from the intermediate flash drums or at an intermediate level of the regenerating column can be sent to an intermediate level of the absorption section. The treated gaseous mixture such as natural gas then undergoes the conventional treatment steps described above, namely the dehydration step, and the stripping-separation step.

The invention also relates to the use of an absorbent solution comprising, preferably constituted by, at least one amine, water, and at least one C₂-C₄ thioalkanol for selectively removing hydrogen sulphide relative to carbon dioxide in a gaseous mixture containing at least hydrogen sulphide and carbon dioxide. The amine, the thioalkanol, the gaseous mixture and the conditions for removal have already been described in detail above.

The invention finally relates to the use of at least one C₂ to C₄ thioalkanol as additive in an absorbent solution comprising at least one amine, and water, for increasing the selectivity of said absorbent solution for the removal of hydrogen sulphide relative to carbon dioxide in a gaseous mixture containing at least hydrogen sulphide and carbon dioxide. Advantageously, the gaseous mixture contains, besides H₂S and CO₂, at least one other sulphur-containing compound (other than H₂S) preferably selected from the mercaptans and COS, and the use of at least one thioalkanol as additive in the absorbent solution comprising at least one amine and water, and moreover makes it possible to increase the removal of said sulphur-containing compound. The removal of the other sulphur-containing compounds through the addition of at least one thioalkanol is generally increased in the proportion already stated above.

### EXAMPLES

### Example 1

In this example, carried out in a pilot plant, it is shown that the addition of TDG to an absorbent solution comprising water and MDEA permits selective removal of H₂S relative to CO₂ in a gaseous mixture.

Brief Description of the Pilot Plant:

The pilot plant for gas treatment by scrubbing used in this example makes it possible to treat from 50 to 1500 Nm³/h of gas at a pressure from 10 to 40 bar with a flow rate of solvent from 100 to 3500 L/h and it comprises:
an absorption loop (40 bar maximum), comprising a column containing 11 plates each with a diameter of 20 cm, and a system of compressors, ejectors and exchangers ensuring circulation of the gas.
a flash section (16 bar maximum) comprising a drum and a condensate pump.
a regeneration section (5 bar maximum) comprising a packed column with a diameter of 30 cm, a preheater, a steam reboiler, a condensate pump, a top condenser with water, a top condenser with a cold unit, and decompression of the acidic gas.
a storage section comprising a water cooler, a storage tank and a condensate pump.

Test Conditions and Results:

The tests were carried out at 18 and 40 bar. The gas flow rate is fixed at 283 Nm³/h. The gas consists predominantly of an inert gas, namely nitrogen, for these tests.

The gas to be treated contains 1.5 to 1.6 mol % of H₂S, and from 1.6 to 1.7 mol % of CO₂ for the tests at 18 bar; and from 1.5 to 1.6 mol % of H₂S, and from 1.3 to 1.5 mol % of CO₂ for the tests at 40 bar. The gas is brought into contact with the solvent in the absorber. The solvent flow rate is fixed at 295 L/h for the tests. The tests were conducted with a so-called reference absorbent solution: water-MDEA 55-45% by weight, and an absorbent solution used according to the invention: water-MDEA-TDG 38-45-17% by weight.

The concentration of H₂S or CO₂ is measured by analysis by gas chromatography at the level of the different plates along the column. The results of the tests carried out at 18 bar and at 40 bar are shown in FIGS. 1, 2; and 3, 4, respectively. These figures show that the two absorbent solutions allow identical rates of removal to be reached for H₂S. The selective properties of the water-MDEA-TDG absorbent solution used according to the invention make it possible, owing to the presence of TDG, to limit the quantity of CO₂ coabsorbed.

### Example 2

In this example, carried out in the laboratory, it is shown that there is a decrease in absorption flow with an increase in the thioalkanol content of the absorbent solution. The tests were therefore carried out under similar conditions, the only variable being finally the TDG content of the absorbent solution. Measurements of absorption flow of CO₂ were carried out in a reactor permitting control of the contact area between the gas and the solvent. The tests were carried out at constant temperature, namely 60° C. The reactor used is a closed reactor.

The absorbent solution is introduced into the reactor first, then in its turn a given quantity of carbon dioxide is introduced into the reactor. Then the pressure drop resulting from the phenomenon of absorption of the gas in the absorbent solution is measured. The effect of the properties of the absorbent solution on absorption is then quantified by examining the flow, obtained by varying the pressure and geometry of the reactor, standardized by the carbon dioxide pressure in the reactor at the moment of measurement. The graphs in FIGS. 5 and 6 show a notable reduction in absorption with an increase in the TDG content, whether with a water-DEA-TDG absorbent solution, at 60° C. (FIG. 5), or with a water-MDEA-TDG absorbent solution (FIG. 6).

1. A process for selectively removing hydrogen sulphide H₂S relative to carbon dioxide CO₂ from a gaseous mixture containing at least hydrogen sulphide H₂S and carbon dioxide CO₂, the process comprising contacting the gaseous mixture with an absorbent solution comprising at least one amine, water, and at least one C₂ to C₄ thioalkanol, wherein water is from 35% to 45% by weight.

2. The process according to claim 1, wherein the gaseous mixture includes, besides H₂S and CO₂, at least one other sulphur-containing compound preferably selected from mercaptans and carbonyl sulphide COS.

3. The process according to claim 1, wherein the hydrogen sulphide content of the gaseous mixture to be treated is comprised between 30 ppm by volume and 40% by volume, and the process further comprises, after the contacting step, lowering this content to 1 ppm by volume.

4. The process according to claim 1, wherein the CO₂ content of the gaseous mixture to be treated is comprised between 0.5% by volume and 80% by volume, preferably between 1% by volume and 50% by volume.

5. The process according to claim 4, wherein the gaseous mixture to be treated comprises at least one mercaptan at a content below 1000 ppm by volume.

6. The process according to claim 2, wherein the gaseous mixture to be treated comprises COS at a content below 200 ppm by volume.

7. The process according to claim 1, wherein the gaseous mixture is selected from natural gases, tail gases obtained at an outlet of sulphur chains, and gases obtained in units treating gases of a refinery.

8. The process according to claim 1, wherein the amine is an alkanolamine.

9. The process according to claim 8, wherein the amine is methyldiethanolamine MDEA.

10. The process according to claim 1, wherein the thioalkanol is ethylene dithioethanol or ThioDiGlycol (TDG).

11. The process according to claim 1, wherein the absorbent solution comprises:
from 40% to 45% by weight of at least one amine;
from 35% to 45% by weight of water; and
from 17% to 25% by weight of at least one thioalkanol.

12. The process according to claim 1, wherein the absorbent solution comprises water, MDEA, and TDG in the respective proportions of 38%, 45%, and 17% by weight.

13. The process according to claim 1, further comprising carrying out the contacting step at a temperature from 40° C. to 10° C., and at a pressure from 1 to 150 bar.

14. The process according to claim 1, further comprising, after the contacting step, regenerating the absorbent solution.

15. The process according to claim 14, further comprising carrying out the step of regenerating the absorbent solution at a pressure from 0 to 20 bar, and at a temperature from 100° C. to 140° C.

16. A process comprising using an absorbent solution comprising at least one amine, at least one C₂-C₄ thioalkanol, and from 35% to 45% by weight of water to selectively remove hydrogen sulphide H₂S relative to carbon dioxide from a gaseous mixture comprising at least hydrogen sulphide and carbon dioxide.

17. A process comprising using at least one C₂ to C₄ thioalkanol as an additive in an absorbent solution comprising at least one amine and from 35% to 45% by weight of water, to increase selectivity of the absorbent solution for the removal of hydrogen sulphide relative to carbon dioxide from a gaseous mixture comprising at least hydrogen sulphide and carbon dioxide.

18. The process according to claim 16, wherein the gaseous mixture comprises, besides H₂S and CO₂, at least one other sulphur-containing compound selected from the mercaptans and carbonyl sulphide COS, and further comprising at least one thioalkanol as an additive in the absorbent solution comprising at least one amine and from 35% to 45% by weight of water increasing removal of a sulphur-containing compound.

19. The process according to claim 1, wherein the absorbent solution comprises:
methyldiethanolamine;
from 35 to 45% by weight of water; and
ethylene dithioethanol or thiodiglycol (TDG).

20. The process according to claim 1, wherein the absorbent solution consists of:
methyldiethanolamine;
from 35 to 45% by weight of water; and
ethylene dithioethanol or thiodiglycol (TDG).

21. The process according to claim 1, wherein the absorbent solution consists of water, methyldiethanolamine (MDEA), and thiodiglycol (TDG) in the respective proportions of 38%, 45%, and 17% by weight.
